(19) United States
(12) Patent Application Publication
(10) Pub. No.: US 2025/0031162 A1
(43) Pub. Date: Jan. 23, 2025

(54) METHOD AND DEVICE FOR TRANSMITTING SYNCHRONIZATION SIGNAL BLOCK IN NON-TERRESTRIAL NETWORK COMMUNICATION SYSTEM

(71) Applicant: ELECTRONICS AND TELECOMMUNICATIONS RESEARCH INSTITUTE, Daejeon (KR)

(72) Inventors: Gyeong Rae IM, Daejeon (KR); Jung Bin KIM, Daejeon (KR); Pan Soo KIM, Daejeon (KR); Min Su SHIN, Daejeon (KR); In Ki LEE, Daejeon (KR); Dong Hyun JUNG, Daejeon (KR); Soo Yeob JUNG, Daejeon (KR); Seung Keun PARK, Daejeon (KR); Joon Gyu RYU, Daejeon (KR)

(73) Assignee: ELECTRONICS AND TELECOMMUNICATIONS RESEARCH INSTITUTE, Daejeon (KR)

(21) Appl. No.: 18/712,650

(22) PCT Filed: Nov. 23, 2022
(86) PCT No.: PCT/KR2022/018638

§ 371 Date: May 22, 2024

(30) Foreign Application Priority Data
Nov. 23, 2021 (KR) 10-2021-0162643

(51) Int. Cl. H04W 56/00; H04W 16/28; H04W 72/0457; H04W 84/06

(52) U.S. Cl. CPC H04W 56/0015; H04W 16/28; H04W 72/0457; H04W 84/06

(57) ABSTRACT

A method according to an embodiment of the present invention corresponds to a method for transmitting, by a gateway, a synchronization signal block (SSB) through a plurality of satellites, and may comprise the steps of: determining satellite identification SSBs for identifying a plurality of satellites, respectively; determining beam identification SSBs for identifying beams usable for the plurality of satellites, respectively; and controlling the satellite identification SSBs and the beam identification SSBs to be transmitted to the plurality of satellites, respectively, through a predetermined resource, wherein the satellite identification SSBs and each of the beam identification SSBs have different SSB indices from each other.

### TECHNICAL FIELD

The present disclosure relates to a method and an apparatus for transmitting synchronization signal blocks, and more particularly, to a method and an apparatus for transmitting synchronization signal blocks in a non-terrestrial communication system.

### BACKGROUND ART

When a terminal (user equipment (UE)) attempts initial access to a base station (g-Node B (gNB)), the gNB may not know information on the UE, and thus the gNB periodically transmits synchronization signal blocks (SSBs) for initial access using beams in various directions. The terminal accesses the gNB and exchanges signals with the gNB through a beam corresponding to an SSB having the highest reception power among received SSBs.

A gNB having multiple beams transmits different SSBs at different times through the respective beams. The gNB transmits several SSBs (e.g., SB #1 to SB #L) during a certain period (i.e., SS burst), and each SSB has a structure of being transmitted through one of L beams.

### DISCLOSURE

### Technical Problem

The present disclosure is directed to providing a technique for allocating a plurality of synchronization blocks for initial access of a terminal to a plurality of beams or bandwidth parts when a plurality of satellites use a plurality of beams.

### Technical Solution

A method according to an exemplary embodiment of the present disclosure for achieving the above-described objective may comprise, as a method for a gateway to transmit synchronization signal blocks (SSBs) through a plurality of satellites, determining satellite identification SSBs for respectively identifying the plurality of satellites; determining beam identification SSBs for respectively identifying beams available for each of the plurality of satellites; and controlling each of the plurality of satellites to transmit the satellite identification SSB and the beam identification SSB through a predetermined resource, wherein the satellite identification SSB and the beam identification SSBs within one satellite have different SSB indexes.

The method may further comprise, when the plurality of satellites transmits beams using a plurality of bandwidth parts, allocating a common bandwidth part used by all beams and a beam-specific bandwidth part corresponding to each beam for each satellite; and controlling the beam identification SSB to be transmitted in the common bandwidth part.

The method may further comprise controlling the beam identification SSB to be transmitted at a different time for each beam.

The method may further comprise controlling the satellite identification SSB to be transmitted through the common bandwidth part.

The method may further comprise controlling the satellite identification SSB to be simultaneously transmitted through all the beams.

The method may further comprise controlling the satellite identification SSB to be transmitted through the beam-specific bandwidth parts.

The method may further comprise: controlling the satellite identification SSB and the beam identification SSB to be transmitted at a same time when transmitted through one beam; and controlling the beam identification SSB to be transmitted at a different time for each beam.

The method may further comprise configuring the satellite identification SSB and the beam identification SSB as a pair, and controlling the satellite identification SSB and the beam identification SSB, which are configured as the pair, to be transmitted through the common bandwidth part at a preconfigured time interval.

The method may further comprise controlling the beam identification SSB to be transmitted after the satellite identification SSB is transmitted.

An apparatus according to an exemplary embodiment of the present disclosure for achieving the above-described objective may comprise, as a gateway to transmit synchronization signal blocks (SSBs) through a plurality of satellites, a processor; and a transceiver for communicating with the plurality of satellites. The processor may be configured to: determine satellite identification SSBs for respectively identifying the plurality of satellites; determine beam identification SSBs for respectively identifying beams available for each of the plurality of satellites; and control each of the plurality of satellites to transmit the satellite identification SSB and the beam identification SSB through a predetermined resource, wherein the satellite identification SSB and the beam identification SSBs within one satellite have different SSB indexes.

When the plurality of satellites transmits beams using a plurality of bandwidth parts, the processor may be further configured to: allocate a common bandwidth part used by all beams and a beam-specific bandwidth part corresponding to each beam for each satellite; and control the beam identification SSB to be transmitted in the common bandwidth part.

The processor may be further configured to control the beam identification SSB to be transmitted at a different time for each beam.

The processor may be further configured to control the satellite identification SSB to be transmitted through the common bandwidth part.

The processor may be further configured to control the satellite identification SSB to be simultaneously transmitted through all the beams.

The processor may be further configured to control the satellite identification SSB to be transmitted through the beam-specific bandwidth parts.

The processor may be further configured to: control the satellite identification SSB and the beam identification SSB to be transmitted at a same time when transmitted through one beam; and control the beam identification SSB to be transmitted at a different time for each beam.

The processor may be further configured to configure the satellite identification SSB and the beam identification SSB as a pair, and control the satellite identification SSB and the beam identification SSB, which are configured as the pair, to be transmitted through the common bandwidth part at a preconfigured time interval.

The processor may be further configured to control the beam identification SSB to be transmitted after the satellite identification SSB is transmitted.

A method according to another exemplary embodiment of the present disclosure for achieving the above-described objective may comprise, as a method of transmitting synchronization signal blocks (SSBs), performed by a satellite, receiving, from a gateway, satellite identification SSBs for identifying satellites; determining beam identification SSBs for identifying beams available for the satellite; when beams are transmitted using a plurality of bandwidth parts, allocating a common bandwidth part used by all the beams and a beam-specific bandwidth part corresponding to each beam; configuring the beam identification SSB to be transmitted in the common bandwidth part; and configuring the beam identification SSB to be transmitted at a different time for each beam; and transmitting the satellite identification SSB and the beam identification SSB through respective beams at an SSB transmission time point, wherein the satellite identification SSB and the beam identification SSBs within one satellite have different SSB indexes.

The satellite identification SSB and the beam identification SSB may be transmitted at a same time within one beam, and the beam identification SSBs for different beams may be transmitted at different times.

### Advantageous Effects

According to an exemplary embodiment of the present disclosure, when one or more satellites use one or more beams, multiple synchronization signals may be allocated to the beams. Therefore, when one or more satellites use one or more beams, there is an advantage that a terminal can efficiently acquire initial synchronization.

### DESCRIPTION OF DRAWINGS

FIG. 1A is a diagram illustrating configuration of one SSB in the frequency/time domain.

FIG. 1B is an exemplary diagram for describing a case of transmitting SSBs using an SSB transmission period and multiple beams.

FIG. 2A is an exemplary diagram for describing a procedure for a terminal to search for an optimal beam of a base station.

FIG. 2B is an exemplary diagram for describing a procedure for a terminal to search for an optimal reception beam corresponding to an optimal beam of a base station.

FIG. 3A is an exemplary diagram of an NTN system model having multiple satellites.

FIG. 3B is an exemplary diagram for describing SSB allocation for beam sweeping in the NTN according to the present disclosure.

FIG. 4 is an exemplary diagram for describing SSB transmission considering multiple beams and bandwidth parts of the NTN.

FIG. 5 is a diagram illustrating an SSB allocation method for identifying satellites and beams of each satellite according to an exemplary embodiment of the present disclosure.

FIG. 6A is an exemplary diagram for describing a case in which a satellite identification SSB is transmitted through the BWP0 and all beams according to an exemplary embodiment of the present disclosure.

FIG. 6B is an exemplary diagram for describing a case in which satellite identification SSBs are transmitted in different BWPs for the respective beams according to another exemplary embodiment of the present disclosure.

FIG. 6C is an exemplary diagram for describing a case in which a satellite identification SSB is transmitted in a common BWP according to another exemplary embodiment of the present disclosure.

FIG. 7 is a block diagram illustrating an exemplary embodiment of a communication node constituting a wireless communication network.

FIG. 8 is a control flow diagram for describing a case of transmitting SSBs according to an exemplary embodiment of the present disclosure.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

### [Initial Access Through Beam Search in 5G NR]

When a terminal (user equipment (UE)) attempts initial access to a base station (g-Node B (gNB)), the gNB may not know information on the UE. Accordingly, the gNB periodically transmits synchronization signal blocks (SSBs) for initial access using beams in various directions. The terminal accesses the gNB through a beam corresponding to an SSB having the highest reception power among received SSBs. Thereafter, the terminal exchanges signals with the gNB.

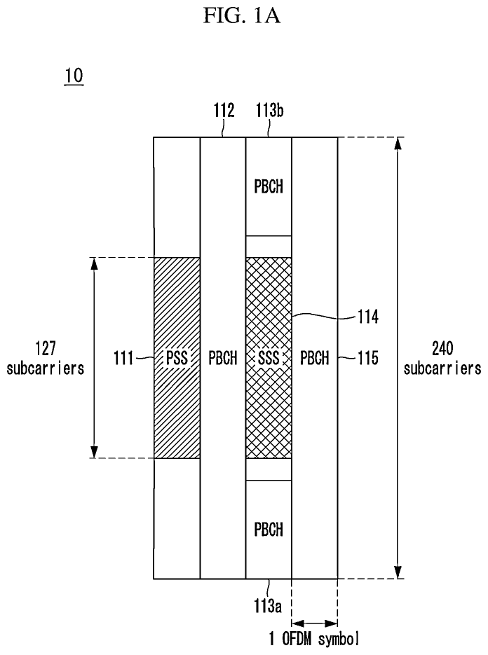

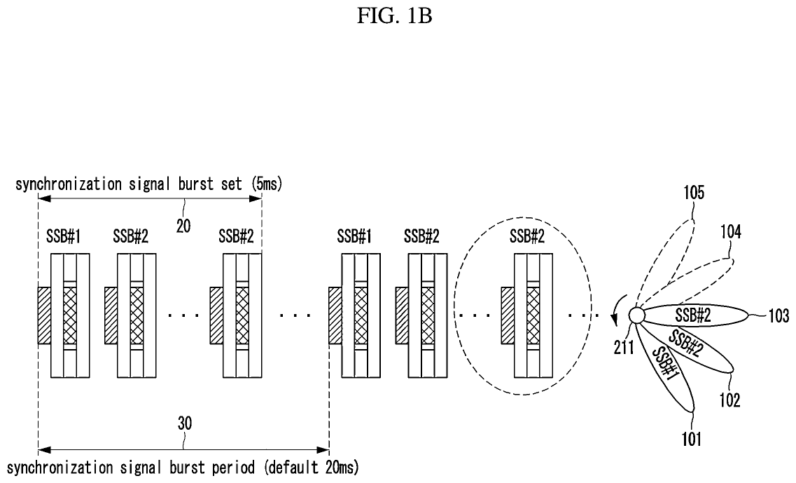

FIG. 1A is a diagram illustrating configuration of one SSB in the frequency/time domain.

Referring to FIG. 1A, one SSB 10 may be composed of four orthogonal frequency division multiplexing (OFDM) symbols. A primary synchronization signal (PSS) 111 may be transmitted in the first symbol among the four OFDM symbols. In this case, the PSS may be transmitted using central 127 subcarriers among 240 subcarriers. In the second OFDM symbol, a physical broadcast channel (PBCH) 112 may be transmitted, and in the third OFDM symbol, a secondary synchronization signal (SSS) 114 may be transmitted in the same subcarriers as those of the PSS. Most of the remaining subcarriers of the third OFDM symbol may be used to transmit PBCHs 113a and 113b. In the last fourth OFDM symbol, a PBCH 115 may be transmitted.

The terminal may acquire initial synchronization and information on a physical cell identification (PCI) based on the PSS 111 and the SSS 114. In addition, the terminal may obtain a master information block (MIB) and configuration information of system information block(s) (SIB(s)) based on the PBCH. That is, through this, the terminal may obtain information on beams of the gNB, and may perform initial access.

FIG. 1B is an exemplary diagram for describing a case of transmitting SSBs using an SSB transmission period and multiple beams.

Referring to FIG. 1B, L SSBs 30 may be transmitted in one synchronization signal (SS) burst set 20 configure as 5 ms. A plurality of SS burst sets 20 may be included in an SS burst set period 30 set to 20 ms by default. In addition, since the synchronization signals need to be transmitted periodically as described above, the SSBs may be continuously transmitted based on the SS burst set period. In FIG. 1B, in order to identify SSBs transmitted at different times, for each SS burst set, L SSBs are numbered to distinguish from each other. Specifically, within one SS burst set 20, numbers are assigned to an SSB #1 transmitted first, an SSB #2 transmitted second, . . . , and an SSB #L transmitted L-th to identify the respective SSBs. The actual configuration of each SSB may have the same form as the SSB described in FIG. 1A.

In addition, a base station using a plurality of beams may allocate one SSB to each of the plurality of beams. The rightmost part of FIG. 1B illustrates an operation in which a base station 211 using a plurality of beams sweeps the plurality of beams, and a form in which the base station 211 respectively allocates SSBs to beams 101, 102, 103, 104, 105, . . . , and the like. Specifically, the base station 211 may transmit the SSB #1 transmitted first within one SS burst set 20 through the first beam 101, transmit the SSB #2 through the second beam 102, and transmit the SSB #3 through the third beam 103. When the SSBs are sequentially allocated to the respective beams in this manner, L beams may be identified using one SS burst set.

### [Beam Matching Process Through Beam Sweeping in 5G NR]

In a terrestrial network, there is a trend to increase radio transmission capacity using a high frequency band such as mmWave and THz communications due to the absence of usable low frequency bands and the increase in the amount of transmission traffic and the number of mobile devices. In the case of mmWave or THz communication, a used frequency band has characteristics of a high path loss according to a transmission distance. In order to overcome this disadvantage, it may be essential to use beamforming in a communication system using such the high frequency band.

However, when signals are concentrated only in a specific direction using beamforming, communication is possible only when selecting a beam in the corresponding direction according to a location of a terminal. Therefore, there is a restriction that signals to be transmitted to the terminal should be transmitted based on information on the location (direction) of the terminal. In this reason, in the 5G NR, the base station periodically transmits SSBs in order for the terminals to synchronize with the base station and to deliver basic system information for initial access. In this case, the base station periodically transmits SSBs having different indexes through beams in different directions. The terminal feeds back an index of an SSB received with the highest power among the SSBs transmitted in various directions to the base station. Accordingly, the base station may identify an optimal beam for the terminal. The procedure for synchronizing the terminal and the base station and finding the optimal beam is referred to as a ‘beam search process’.

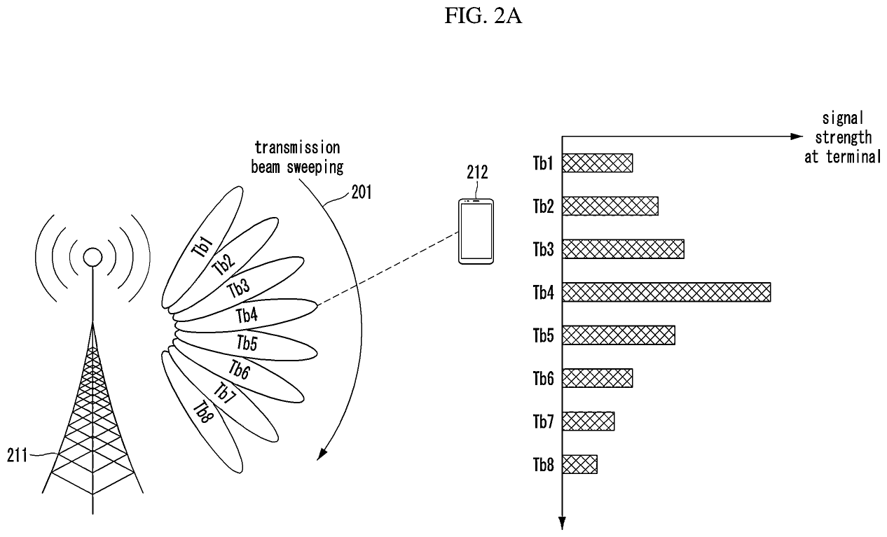

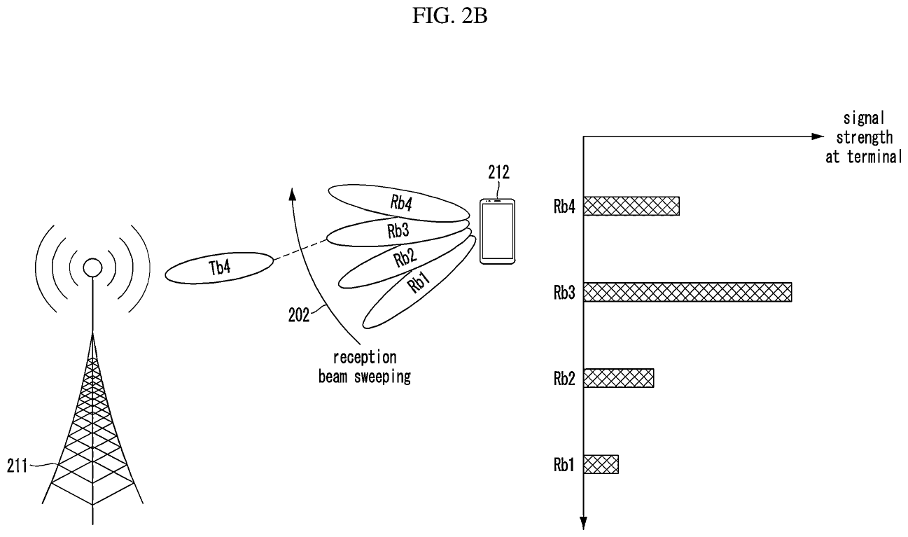

FIG. 2A is an exemplary diagram for describing a procedure for a terminal to search for an optimal beam of a base station, and FIG. 2B is an exemplary diagram for describing a procedure for a terminal to search for an optimal reception beam corresponding to an optimal beam of a base station.

Referring to FIG. 2A, the base station 211 and a terminal 212 are illustrated. A form in which the base station 211 sweeps transmission (TX) beams is exemplified. Specifically, a first transmission beam Tb1, a second transmission beam Tb2, a third transmission beam Tb3, a fourth transmission beam Tb4, a fifth transmission beam Tb5, a sixth transmission beam Tb6, a seventh transmission beam Tb7, and an eighth transmission beam Tb8 are illustrated.

The terminal 212 may receive each of the transmission beams Tb1 to Tb8 transmitted by the base station 211, and measure received signal strengths. As described above with reference to FIGS. 1A and 1B, the base station 211 may transmit different SSBs through the respective transmission beams Tb1 to Tb8.

In the right side of FIG. 2A, the received signal strengths of the respective transmission beams Tb1 to b8 at the terminal 212 are illustrated using a graph. The graph of FIG. 2A may illustrate information (or a value or indicator corresponding to the signal strength) reported by the terminal 212 after the terminal measures the strengths of signals received from the base station 211. Referring to the graph of FIG. 2A, the terminal 212 may identify that the received strength of the fourth transmission beam Tb4 among the transmission beams Tb1 to Tb8 transmitted by the base station 211 is the largest. Accordingly, the terminal 212 and the base station 211 may configure the fourth transmission beam Tb4 as the most suitable beam for mutual communication.

Referring to FIG. 2B, a reception (RX) beam most appropriate for the terminal 211 to receive the fourth transmission beam Tb4 determined between the base station 211 and the terminal 212 may be determined. Accordingly, the terminal 212 may determine a reception beam most appropriate for communication through reception beam sweeping 202 based on a first reception beam Rb1, a second reception beam Rb2, a third reception beam Rb3, and a fourth reception beam Rb4.

FIG. 2B also illustrates a graph obtained by measuring received signal strengths using the respective reception beams Rb1 to Rb4 when receiving the fourth transmission beam Tb4 as described in FIG. 2A. Referring to the graph illustrated in FIG. 2B, it can be seen that the third reception beam Rb3 is the most suitable reception beam for receiving the fourth transmission beam Tb 4. Accordingly, the terminal 212 may use the third reception beam Rb3 to communicate with the base station 211.

### [Non Terrestrial Network (NTN) Communication]

In a low earth orbit (LEO)-based non-terrestrial network (NTN) environment, the number of LEO satellites may be more than the number of terrestrial gateways (GWs). In this environment, a plurality of satellites may belong to one GW. Therefore, the NTN environment may be similar to an environment in which there is a terrestrial network base station and RF repeaters are installed to cover shadow areas of the terrestrial network base station. In this case, the LEO satellites may provide communication services to different regions.

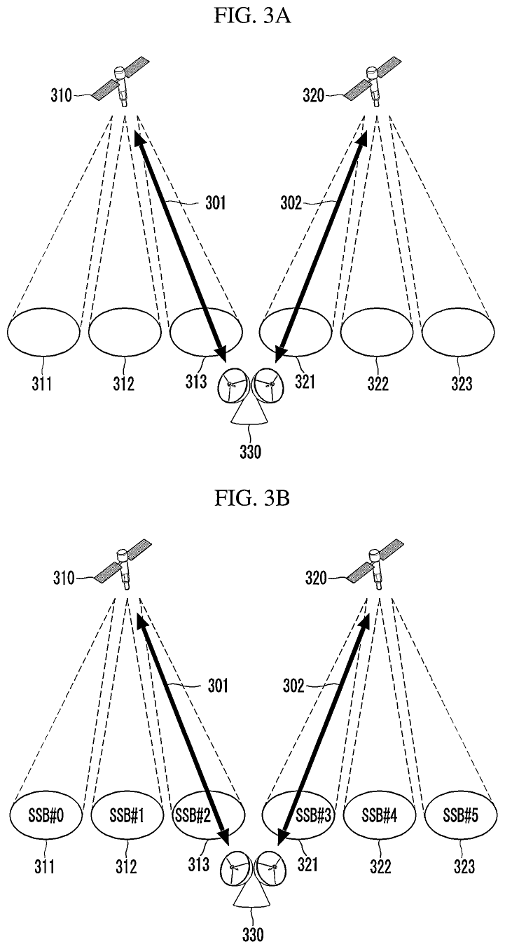

FIG. 3A is an exemplary diagram of an NTN system model having multiple satellites.

Referring to FIG. 3A, a first satellite 310, a second satellite 320, and a terrestrial station (or GW, gNB, or gNB-CU) 330 are illustrated. The first satellite 310 may configure a first communication coverage 311 using one beam (first beam) among three different beams, configure a second communication coverage 312 using another beam (second beam) among the three different beams, and configure a third communication coverage 313 using the remaining one beam (third beam) among the three different beams. In addition, the second satellite 320 may also configure a first communication coverage 321 using one beam among three different beams, configure a second communication coverage 322 using another beam among the three different beams, and configure a third communication coverage 323 using the remaining one beam among the three different beams. In FIG. 3A, a form in which one satellite covers three different coverages using three different beams is illustrated, but this is only an example for convenience of description. The present disclosure may apply operations described below to all cases in which one satellite has coverages corresponding to the number of beams through two or more beams.

In addition, the terrestrial station 330 may establish a link 301 for communication with the first satellite 310 and a link 302 for communication with the second satellite 320. The terrestrial station 330 may be a gateway (GW). In the following description, the terrestrial station may be described as a GW, base station, gNB, or gNB-CU. The gNB-CU may mean a control unit (CU) that performs control in the gNB when a base station is split into the CU and distributed unit(s) (DU(s)) or remote unit(s) (RU(s)).

As illustrated in FIG. 3A, the GW 330 located on the ground may have multiple antennas (not shown), and may establish the single-input single-output (SISO) links 301 and 302 with the satellites 310 and 320, respectively. In addition, each of the satellites 310 and 320 may relay signals of the GW 330 using multiple beams in order to provide services to terrestrial terminals. In such the NTN environment, scheduling for the terminals and data transmission based on the scheduling may be performed by the GW 330. Accordingly, in the NTN environment illustrated in FIG. 3A, all the communication coverages 311, 312, 313, 321, 322, and 323 of the satellites 310 and 320 may be regarded as one cell. Therefore, in the process of initial access by the terminal, it is required to find out which beam of which satellite the terminal belongs to. The process of finding which beam of which satellite the terminal belongs to in this manner may be similar to the previously described 5G NR beam sweeping, that is, the beam search process.

However, in the multi-satellite based NTN environment, where the GW 330 serves as a base station and there are multiple satellites, a change is required in the step of configuring an optimal beam by the terminal. Specifically, there may be the satellites between the gNB or gNB-CU in the GW 330 and the terminals, and each of the satellites also supports multiple beams and polarizations. In general, controls on the beams of the satellites according to circumstances may be performed by the gNB or gNB-CU in the GW 330. In general, scheduling and beam controls based on the location of the terminal may be performed by the gNB or gNB-CU. In addition, information for controlling the beams of the satellites may be ultimately transmitted after all decisions are made in the GW 330, and accordingly the NTN operates. Therefore, it should be possible to simultaneously find out a beam from the gNB or gNB-CU to the satellite (i.e., satellite selection) and a beam from the satellite to the terminal. Accordingly, when two or more satellites are connected to one GW in the NTN environment, two-step beam sweeping may be required. In addition, to support this, the SSB indexing scheme needs to be changed.

FIG. 3B is an exemplary diagram for describing SSB allocation for beam sweeping in the NTN according to the present disclosure.

Referring to FIG. 3B, it has the same form as the previously described FIG. 3A. However, a form in which different SSB indexes are assigned to beams transmitted from the satellites 310 and 320 to the terminal according to the present disclosure is exemplified. Specifically, an SSB having an index of SSB #0 may be allocated to the first communication coverage 311 based on the first beam of the first satellite 310, an SSB having an index of SSB #1 may be allocated to the second communication coverage 312 based on the second beam of the first satellite 310, and an SSB having an index of SSB #2 may be allocated to the third communication coverage 313 based on the third beam of the first satellite 310. In addition, an SSB having an index of SSB #3 may be allocated to the first communication coverage 321 based on the first beam of the second satellite 320, an SSB having an index of SSB #4 may be allocated to the second communication coverage 322 based on the second beam of the second satellite 320, and an SSB having an index of SSB #5 may be allocated to the third communication coverage 323 based on the third beam of the second satellite 320.

The scheme illustrated in FIG. 3B is the simplest scheme and may be a scheme of assign one different index to each of all beams included in all satellites connected to one GW 330. Accordingly, if each satellite can allocate four beams and there are two satellites as illustrated in FIG. 3B, indexes may be assigned to identify a total of eight beams. As another example, if there are four satellites and each satellite can allocate three beams as illustrated in FIG. 3B, indexes may be assigned to identify a total of twelve satellites.

However, in the case of using the scheme described above, there may be a problem in that the number of SSBs to be transmitted during an SSB transmission period increases.

In order to partially solve this problem, a scheme of assigning a satellite index and a beam index separately may be considered. That is, SSBs may be divided into two groups, one SSB group may be used to identify a satellite, and the other SSB group may be used to identify beams supported by one satellite. In this case, a scheme of operating as if the GW 330 operates a plurality of cells and assigning a cell identifier (i.e., cell ID) to each satellite may be considered.

However, in this case, inter-cell interference problems and frequent handover problems due to fast movement of satellites may be caused. Therefore, in the present disclosure, the scheme of assigning a cell identifier (cell ID) to each satellite is not considered. That is, it is assumed that all satellites belonging to one GW 330 have the same cell ID (cell ID).

Accordingly, in the present disclosure, a new means for distinguishing satellites is required. Therefore, a scheme of adding a satellite ID along with a cell ID in the SSB may be considered. However, since adding a new field to the SSB changes the existing specifications of NR too much, there is a lot of burden. Considering these problems, the present disclosure is directed to proposing a method for explicitly or implicitly identifying (or including) a satellite ID while maintaining the structure of the existing SSB.

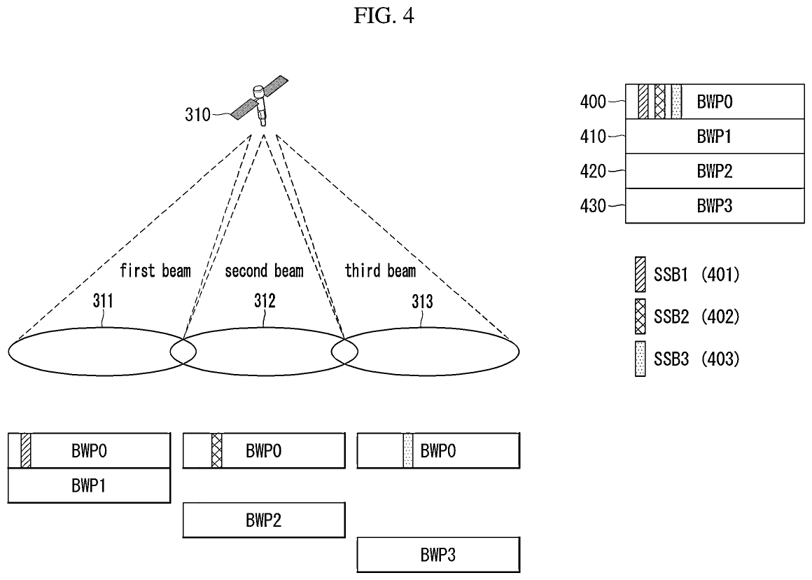

FIG. 4 is an exemplary diagram for describing SSB transmission considering multiple beams and bandwidth parts of the NTN.

FIG. 4 may be a form illustrating only a portion of the first satellite 310 previously described in FIG. 3A. Therefore, the same reference numerals are used for the same parts.

Referring to FIG. 4, the first satellite 310 may transmit data to terminals located in the first communication coverage 311 using the first beam, the second communication coverage 312 using the second beam, and the third communication coverage 313 using the third beam. In addition, referring to FIG. 4, the first communication coverage 311 has a handover region overlapping the second communication coverage 312, and the second communication coverage 312 has a handover region overlapping the third communication coverage 313.

In the right side of the satellite of FIG. 4, four different bandwidth parts (BWPs) 400, 410, 420, and 430 are illustrated. Among the four different BWPs 400, 410, 420, and 430, a common BWP0 400 may be transmitted in each of the communication coverages 311, 312, and 313 configured by the first, second, and third beams. In addition, the first BWP 410 is allocated to the first communication coverage 311 using the first beam, the second BWP 420 is allocated to the second communication coverage 312 using the second beam, and the third BWP 430 is allocated to the third communication coverage 313 using the third beam. This is illustrated in FIG. 4 at the bottom of the communication coverages 311, 312, and 313 configured by the respective beams.

In addition, when transmitted in the communication coverages 31, 312, and 313 formed by the respective beams in accordance with the present disclosure, different SSBs 401, 402, and 403 may be allocated to the BWP0 400 which is the common BWP. For example, when the BWP0 400 is allocated to the first communication coverage 311 through the first beam, the SSB1 401 may be transmitted. When the BWP0 400 is allocated to the second communication coverage 312 through the second beam, the SSB2 402 may be transmitted. When the BWP0 400 is allocated to the third communication coverage 313 through the third beam, the SSB 403 may be transmitted. As described above, the respective beams may be identified by allocating different SSBs 401, 402, and 403 to the common BWP 400 (i.e., BWP0).

Meanwhile, in FIG. 4, the case in which one satellite has four bands has been described as an example. However, it is also possible for one satellite to have four or more bands. For example, assuming that one satellite has five bands, as illustrated in FIG. 4, one BWP0 400 common to the respective beams may be configured, and one BWP may be allocated to each beam. In addition, the remaining one BWP may be allocated in one of the following schemes.
1) Allocate to any one of the three beams
2) Allocate to a beam of a coverage with the most traffic among the communication coverages formed by the three beams
3) Allocate to a beam of a coverage with the largest number of terminals among the communication coverages formed by the three beams
4) Allocate to a beam having many handover regions among the communication coverages formed by three beams, for example, allocate to the second beam

In addition to the schemes mentioned above, various conditions may be considered when the BWPs cannot be allocated uniformly.

Meanwhile, the schemes described above can identify beams transmitted from the satellite to the terminal, but has a problem in that different satellites cannot be distinguished. Accordingly, a method for identifying each satellite will be described below.

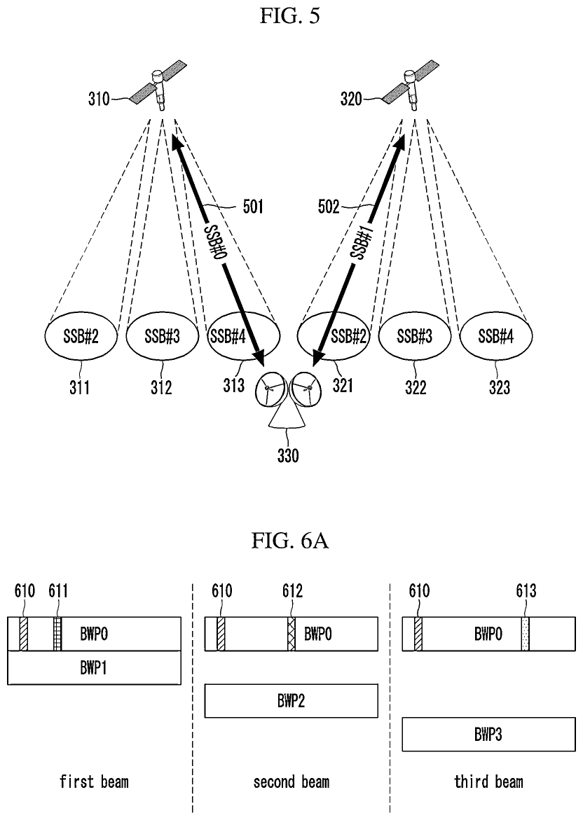

FIG. 5 is a diagram illustrating an SSB allocation method for identifying satellites and beams of each satellite according to an exemplary embodiment of the present disclosure.

Referring to FIG. 5, the first satellite 310, the second satellite 320, and the GW 330 are illustrated. In addition, as described in FIGS. 3A and 3B, the first satellite 310 configures the first communication coverage 311 by using one beam (first beam) among three different beams, configures the second communication coverage 312 using another beam (second beam) among the three different beams, and configures the third communication coverage 313 using the remaining one beam (third beam) among the three different beams. In addition, the second satellite 320 also configures the first communication coverage 321 using one beam (first beam) among three different beams, configures the second communication coverage 322 using another beam (second beam) among the three different beams, and configures the third communication coverage 323 using the remaining one beam (third beam) among the three different beams.

In addition, the GW 330 may allocate the SSB #0 to the first satellite 310 (501) and allocate the SSB #1 to the second satellite 320 (502). Accordingly, the first satellite 310 may transmit the SSB #0 by including the SSB #0 in a transmitted beam, so that it can be distinguished from the adjacent second satellite 320. In addition, the second satellite 320 may transmit the SSB #1 by including the SSB #1 in a transmitted beam, so that it can be distinguished from the adjacent first satellite 310. In FIG. 5, assuming that there are two satellites, the SSB #0 and the SSB #1 are used for distinguishing the respective satellites. However, when three or more satellites need to be distinguished, three different SSB block indexes such as SSB #0, SSB #1, and SSB #2 may be used for identification. In addition, if the three different satellites are not adjacent to each other between the first satellite and a third satellite, two SSB identifiers described above may be sequentially and alternately used for identification.

In addition, the first beam of the first satellite 310 may transmit the SSB #2, the second beam of the first satellite 310 may transmit the SSB #3, and the third beam of the first satellite 310 may transmit the SSB #4. Through this, the respective beams transmitted from one satellite may be distinguished as described above in FIG. 4. Similarly, the first beam of the second satellite 320 may transmit the SSB #2, the second beam of the second satellite 320 may transmit the SSB #3, and the third beam of the second satellite 320 may transmit the SSB #4. Therefore, the respective beams transmitted from the second satellite 320 also may be distinguished.

That is, as described above, an SSB serving as a satellite ID in the SSB structure is additionally defined, and the satellite may be distinguished through the SSB. Accordingly, the first satellite 310 and the second satellite 320 may use the SSB #0 and the SSB #1 during one SSB period to distinguish between the two satellites. The SSB #2 to SSB #4 may be transmitted for the purpose of identifying beams supported by one satellite. Here, the SSB #0 or the SSB #1 for satellite identification may be transmitted from each satellite so that it can be received through all beams, and the SSB #2 to SSB #4 may be transmitted using one beam in a manner in which each satellite selects the one beam.

If an SSB is transmitted in all beam directions, a reception SNR of the SSB at the terminal may be lowered. Therefore, in order to overcome this, the SSB for satellite identification should also be transmitted in respective beams. The method described above assumes the minimum role of the satellite. That is, even in the transparent payload case of the satellite, it can be said to be an extreme case.

Then, a method of transmitting the SSB in the respective beams and BWPs according to the method described above will be described in detail.

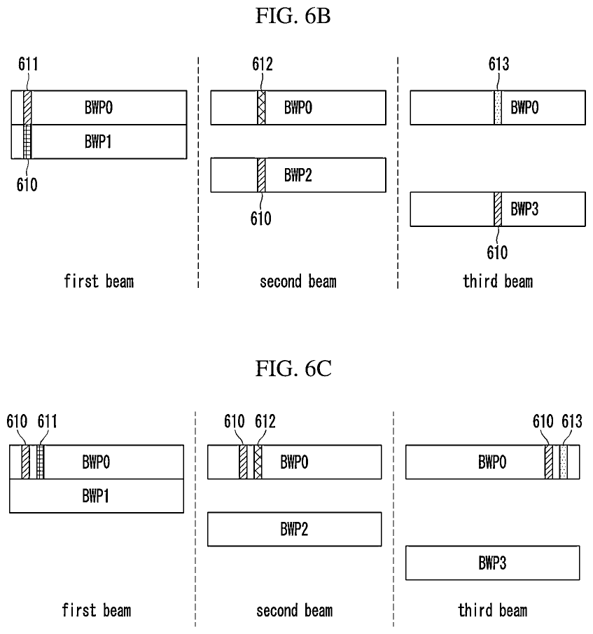

FIG. 6A is an exemplary diagram for describing a case in which a satellite identification SSB is transmitted through the BWP0 and all beams according to an exemplary embodiment of the present disclosure.

Prior to referring to FIG. 6A, it is assumed that each of the satellites 310 and 320 can use two or more of the four BWPs (i.e., BWP0, BWP1, BWP2, and BWP3), and one base station has independent communication coverages using three different beams. However, if each of the satellites 310 and 320 has more than four bands, a concept of FIG. 6A may be applied based on the scheme described above with reference to FIG. 4.

Referring to FIG. 6A, the satellite may communicate using a common bandwidth part BWP BWP0 and a bandwidth part BWP1 allocated to the first beam through the first beam. In addition, the satellite may communicate using the common bandwidth part BWP0 and a bandwidth part BWP2 allocated to the second beam through the second beam. In addition, the satellite may communicate using the common bandwidth part BWP0 and a bandwidth part BWP3 allocated to the third beam through the third beam.

Accordingly, it can be seen that the satellite uses the BWP0 through all of the first to third beams. The remaining BWP1, BWP2, and BWP3 may distinguish the beams of the corresponding satellite. However, since the BWP0 is transmitted through all beams, it cannot be distinguished from which satellite the BWP0 is transmitted. Therefore, as described above, a signal for distinguishing satellites is also required. In the present disclosure, the BWP0 is configured to include a satellite identification SSB 610 for identifying the satellite and beam identification SSBs 611, 612, and 613 for identifying the respective beams. In this case, SSBs for satellite identification have satellite-specific IDs, so that when the terminal demodulates them, it should be able to know from which satellite the signal is transmitted (e.g., when the terminal demodulates the SSB #0 and the SSB #1, which are satellite identification SSBs respectively transmitted from the first and second satellites, the terminal should be able to distinguish the first and second satellites).

Considering this together with FIG. 5, the first satellite 310 may transmit the SSB #0 as the satellite identification SSB 610 for satellite identification when transmitting a signal of the BWP0 using the first beam, and may transmit the SSB #2 as the first beam identification SSB 611 for identifying the first beam among the three beams. In addition, the first satellite 310 may transmit the SSB #0 as the satellite identification SSB 610 for satellite identification when transmitting a signal of the BWP0 using the second beam, and may transmit the SSB #3 as the second beam identification SSB 612 for identifying the second beam among the three beams. In addition, the first satellite 310 may transmit the SSB #0 as the satellite identification SSB 610 for satellite identification when transmitting a signal of the BWP0 using the third beam, and may transmit the SSB #4 as the third beam identification SSB 613 for identifying the third beam among the three beams.

By distinguishing the satellite identification SSB and the beam identification SSB, the satellite and the beam can be identified. In addition, in all beams (first to third beams), the satellite identification SSB may be configured to be transmitted at the same location, and the beam identification SSBs may be configured to be transmitted at different locations for the respective beams.

In the same manner as in FIG. 5, SSBs may be allocated to the respective beams of the second satellite 320 as follows. The second satellite 320 may transmit the SSB #1 as the satellite identification SSB 610 for satellite identification when transmitting a signal of the BWP0 using the first beam, and may transmit the SSB #2 as the first beam identification SSB 611 for identifying the first beam among the three beams. In addition, the second satellite 320 may transmit the SSB #1 as the satellite identification SSB 610 for satellite identification when transmitting a signal of the BWP0 using the second beam, and may transmit the SSB #3 as the second beam identification SSB 612 for identifying the second beam among the three beams. In addition, the second satellite 320 may transmit the SSB #1 as the satellite identification SSB 610 for satellite identification when transmitting a signal of the BWP0 using the third beam, and may transmit the SSB #4 as the third beam identification SSB 613 for identifying the third beam among the three beams.

As described above with reference to FIG. 6A, the satellite identification SSB and the beam identification SSB are separately configured, the satellite identification SSB may be configured to be transmitted in all beams that can be transmitted from the corresponding satellite, and the beam identification SSBs may be configured to be transmitted in the respective beams. In addition, in all beams (first to third beams), the satellite identification SSB may be transmitted at the same location (time point), and the beam identification SSBs may be transmitted at different locations (time points) for the respective beams.

In this manner, SSB indexes are determined to distinguish the respective satellites and beams from each satellite, and each satellite and a beam from a specific satellite can be distinguished by transmitting an SSB according to a timing corresponding to an index of the SSB. In actual transmission, the SSB #0 for satellite identification is transmitted through all beams included in one satellite, and when the process of transmitting the satellite identification SSB for satellite identification ends, the beam identification SSBs may be sequentially transmitted through the respective beams. That is, all the SSBs may be transmitted through the BWP 0.

The case described in FIG. 6A is the simplest, but as described above, since the SSB #0 is transmitted through all beams at the same time, the SSB #0 has inevitably a lower reception SNR than other SSBs.

FIG. 6B is an exemplary diagram for describing a case in which satellite identification SSBs are transmitted in different BWPs for the respective beams according to another exemplary embodiment of the present disclosure.

In FIG. 6B, the previously described assumptions of FIG. 6A are used as they are. That is, it is assumed that each of the satellites 310 and 320 can use two or more of the four BWPs, and one base station has independent communication coverages using three different beams. In addition, if each of the satellites 310 and 320 has more than four bands, a concept of FIG. 6B may be applied based on the scheme described above with reference to FIG. 4.

Referring to FIG. 6B, the satellite may communicate using a common bandwidth part BWP0 and a bandwidth part BWP1 allocated to the first beam through the first beam. In addition, the satellite may communicate using the common bandwidth BWP BWP0 and a bandwidth part BWP2 allocated to the second beam through the second beam. In addition, the satellite may communicate using the common bandwidth part BWP0 and a bandwidth part BWP3 allocated to the third beam through the third beam. Accordingly, it can be seen that the satellite uses the BWP0 through all of the first to third beams. The remaining BWP1, BWP2, and BWP3 may be used to distinguish the beams of the corresponding satellite.

Since the BWP0 is transmitted through all beams, it cannot be distinguished from which satellite the BWP0 is transmitted. Accordingly, the BWP0 may include a beam identification SSB in order to distinguish through which beam the BWP0 is transmitted.

Specifically, considering this together with FIG. 5, the first satellite 310 may transmit the SSB #2 as the first beam identification SSB 611 to distinguish the first beam among the three beams when transmitting a signal of the BWP0 using the first beam. In addition, the first satellite 310 may transmit the SSB #3 as the second beam identification SSB 612 to distinguish the second beam among the three beams when transmitting a signal of the BWP0 using the second beam. In addition, the first satellite 310 may transmit the SSB #4 as the third beam identification SSB 613 to distinguish the third beam among the three beams when transmitting a signal of the BWP0 using the third beam.

In FIG. 6B, by allocating the beam identification SSB to the common BWP allocated to all of the first to third beams in the first satellite 310, it is possible to distinguish through which beam the common BWP is transmitted. In FIG. 6B, the beam identification SSBs 611, 612, and 613 for identifying beams of each satellite are arranged at different times. Through this, SSBs of the common BWP transmitted through all beams of the satellite are arranged at different times, thereby improving reception SNR.

In addition, the satellite identification SSB 610 may be transmitted in the BWPs BWP1, BWP2, and BWP3 configured for the respective beams of the satellite. In this case, the satellite identification SSB 610 may be transmitted simultaneously with the beam identification SSB assigned to the common BWP BWP0 allocated to the respective beams.

In the same manner as in FIG. 5, SSBs may be allocated to the respective beams of the second satellite 320 as follows. The second satellite 320 may transmit the SSB #2 as the first beam identification SSB 611 to distinguish the first beam among the three beams when transmitting a signal of the BWP0 using the first beam. In addition, the second satellite 320 may transmit the SSB #3 as the second beam identification SSB 612 to distinguish the second beam among the three beams when transmitting a signal of the BWP0 using the second beam. In addition, the second satellite 320 may transmit the SSB #4 as the third beam identification SSB 613 to distinguish the third beam among the three beams when transmitting a signal of the BWP0 using the third beam.

In FIG. 6B, by allocating the beam identification SSB to the common BWP allocated to all of the first to third beams in the second satellite 320, it is possible to distinguish through which beam the common BWP is transmitted. In addition, as described above in FIG. 6A, since different SSBs rather than the same SSB are transmitted at different times, the reception SNR may be improved as compared to the case of FIG. 6A.

In addition, the satellite identification SSB 610 may be transmitted in the BWPs BWP1, BWP2, and BWP3 configured for the respective beams of the satellite. In this case, the satellite identification SSB 610 may be transmitted simultaneously with the beam identification SSB allocated to the common BWP BWP0 allocated to the respective beams.

In the scheme described in FIG. 6B, the beam identification SSBs (i.e., SSB #2 to SSB #4), which are transmitted for beam (or BWP) identification, may be transmitted through the common BWP (i.e., BWP0), and at the same time, they may be transmitted through the respective BWPs (i.e., BWP1 to BWP3) corresponding to the respective beams. In FIG. 6B, a case in which the satellite identification SSB and the beam identification SSB are transmitted simultaneously when they are transmitted through a specific beam is illustrated. However, when the satellite identification SSB and the beam identification SSB are transmitted through a specific beam, they may be configured to be transmitted with an interval according to a pre-configured time.

When the SSBs are configured to be transmitted in the scheme described above, the terminal may know an index of a beam to which it belongs through an SSB received in the common BWP (i.e., BWP0), and may know an index of a satellite serving itself through a satellite identification SSB transmitted through a beam-specific BWP that is another BWP.

FIG. 6C is an exemplary diagram for describing a case in which a satellite identification SSB is transmitted in a common BWP according to another exemplary embodiment of the present disclosure.

Prior to referring to FIG. 6C, it is assumed that each of the satellites 310 and 320 can use two or more of the four BWPs (i.e., BWP0, BWP1, BWP2, and BWP3), and one base station has independent communication coverages using three different beams. However, if each of the satellites 310 and 320 has more bands than four bands, a concept of FIG. 6C may be applied based on the scheme described above with reference to FIG. 4.

Referring to FIG. 6C, the satellite may communicate using a common bandwidth part BWP0 and a bandwidth part BWP1 allocated to the first beam through the first beam. In addition, the satellite may communicate using the common BWP BWP0 and a bandwidth part BWP2 allocated to the second beam through the second beam. In addition, the satellite may communicate using the common BWP BWP0 and a bandwidth part BWP3 allocated to the third beam through the third beam. Accordingly, it can be seen that the satellite uses the BWP0 through all of the first to third beams. The remaining BWP1, BWP2, and BWP3 may be used to distinguish beams of the corresponding satellite. Since the BWP0 is transmitted through all beams, it cannot be distinguished through which beam the BWP0 is transmitted. Therefore, as described in FIG. 6A, in the present disclosure, the satellite identification SSB 610 for satellite identification and the beam identification SSBs 611, 612, and 613 for beam identification may be configured to be transmitted in the common BWP BWP0.

Considering this together with FIG. 5, as described in FIG. 6A, the first satellite 310 may transmit the SSB #0 as the satellite identification SSB 610 for satellite identification when transmitting a signal of the BWP0 using the first beam, and transmit the SSB #2 as the first beam identification SSB 611 to distinguish the first beam among the three beams. In addition, the first satellite 310 may transmit the SSB #0 as the satellite identification SSB 610 for satellite identification when transmitting a signal of the BWP0 signal using the second beam, and transmit the SSB #3 as the second beam identification SSB 612 to distinguish the second beam among the three beams. In addition, the first satellite 310 may transmit the SSB #0 as the satellite identification SSB 610 for satellite identification when transmitting a signal of the BWP0 signal using the third beam, and transmit the SSB #4 as the second beam identification SSB 613 to distinguish the third beam among the three beams.

In the case of FIG. 6A, satellite identification SSBs are configured to be transmitted through all beams at the same time, but in FIG. 6C, there is a difference in that satellite identification SSBs are configured to be transmitted at different times.

In addition, a time interval between a satellite identification SSB and a beam identification SSB paired therewith may be a predetermined time interval. For example, assuming that a time interval between the satellite identification SSB 610 and the first beam identification SSB 611, which are transmitted through the first beam, is T1, a time interval between the satellite identification SSB 610 and the second beam identification SSB 612, which are transmitted through the second beam, may also be T1, and a time interval between the satellite identification SSB 610 and the third beam identification SSB 613, which are transmitted through the third beam, may also be T1.

As another example, a time interval between a satellite identification SSB and a beam identification SSB paired therewith may be configured differently for each beam. For example, assuming that a time interval between the satellite identification SSB 610 and the first beam identification SSB 611, which are transmitted through the first beam, is T1, a time interval between the satellite identification SSB 610 and the second beam identification SSB 612, which are transmitted through the second beam, may be T2 different from T1, and a time interval between the satellite identification SSB 610 and the third beam identification SSB 613, which are transmitted through the third beam, may be T3 different from T1 and T2.

Similarly to the case of FIG. 5, SSBs may be allocated to the respective beams of the second satellite 320 as follows. The second satellite 320 may transmit the SSB #1 as the satellite identification SSB 610 for satellite identification when transmitting a signal of the BWP0 using the first beam, and transmit the SSB #2 as the first beam identification SSB 611 to distinguish the first beam among the three beams. In addition, the second satellite 320 may transmit the SSB #1 as the satellite identification SSB 610 for satellite identification when transmitting a signal of the BWP0 using the second beam, and transmit the SSB #3 as the second beam identification SSB 612 to distinguish the second beam among the three beams. In addition, the second satellite 320 may transmit the SSB #1 as the satellite identification SSB 610 for satellite identification when transmitting a signal of the BWP0 using the third beam, and transmit the SSB #4 as the third beam identification SSB 613 to distinguish the third beam among the three beams.

In the case of FIG. 6A, the satellite identification SSBs are configured to be transmitted through all beams at the same time, but in FIG. 6C, there is a difference in that the satellite identification SSBs are configured to be transmitted at different times.

As a result, the case of FIG. 6C may be interpreted as follows. Each satellite configures a pair of satellite identification SSB and beam identification SSB for each beam to be transmitted, and the satellites may transmit these pairs through different beams so that each satellite and each beam can be identified.

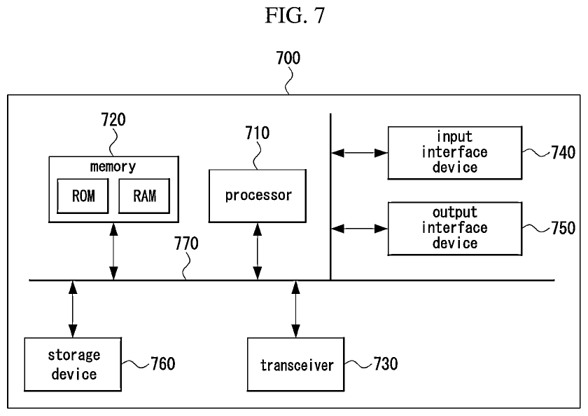

FIG. 7 is a block diagram illustrating an exemplary embodiment of a communication node constituting a wireless communication network.

Referring to FIG. 7, a communication node 700 may comprise at least one processor 710, a memory 720, and a transceiver 730 connected to the network for performing communications. Also, the communication node 700 may further comprise an input interface device 740, an output interface device 750, a storage device 760, and the like. Each component included in the communication node 700 may communicate with each other as connected through a bus 770.

However, each component included in the communication node 700 may be connected to the processor 710 via an individual interface or a separate bus, rather than the common bus 770. For example, the processor 710 may be connected to at least one of the memory 720, the transceiver 730, the input interface device 740, the output interface device 750, and the storage device 760 via a dedicated interface.

The processor 710 may execute a program stored in at least one of the memory 720 and the storage device 760. The processor 710 may refer to a central processing unit (CPU), a graphics processing unit (GPU), or a dedicated processor on which methods in accordance with exemplary embodiments of the present invention are performed. Each of the memory 720 and the storage device 760 may be constituted by at least one of a volatile storage medium and a non-volatile storage medium. For example, the memory 720 may comprise at least one of read-only memory (ROM) and random access memory (RAM).

The communication node 700 described above may be one of the GW, base station, gNB, or gNB-CU according to the present disclosure. The communication node 700 may also be the satellite according to the present disclosure. In addition, the communication node 700 may be the terminal that receives signals transmitted from the GW through the satellite.

If the communication node 700 is one of the GW, base station, gNB, or gNB-CU, it may control the satellite to transmit beams according to the SSB transmission scheme described above. If the communication node 700 is the satellite, it may transmit the beams according to the SSB transmission scheme described above. If the communication node 700 is the terminal, the terminal may receive the SSBs based on the above-described SSB transmission scheme, perform a synchronization acquisition procedure and a RACH procedure, and distinguish the satellites and the respective beams of the satellites. In addition, when the communication node 700 is the terminal, the terminal may transmit information for identification of a satellite or beam with which the terminal is currently communicating (or from which the terminal is currently receiving data) to one of the GW, base station, gNB, or gNB-CU.

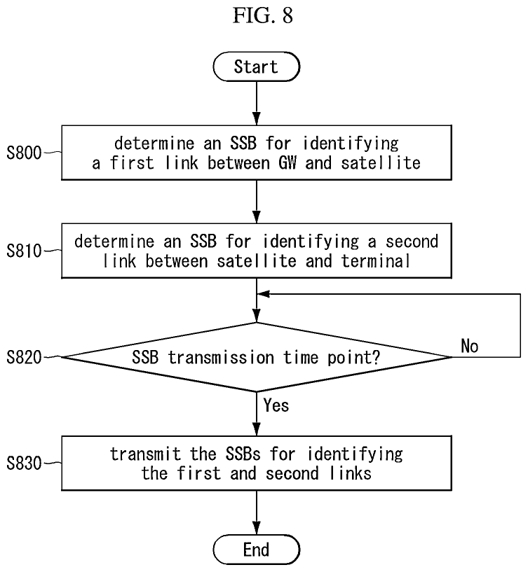

FIG. 8 is a control flow diagram for describing a case of transmitting SSBs according to an exemplary embodiment of the present disclosure.

The operation of FIG. 8 may be performed by one of the GW, base station, gNB, gNB-CU, or satellite. In the following description, it will be described in a form of controlling the satellite by the GW.

In step S800, the GW may determine an SSB for identifying a first link between the GW and the satellite. Here, determining the SSB for identifying the first link may be understood as the same as determining an SSB for identifying the satellite. Accordingly, the operation of determining a satellite identification SSB described above may be performed. Thereafter, the GW may inform the satellite of the SSB for identifying the first link in step S800. As another example, the GW may not inform the satellite of the SSB for identifying the first link in step S800. In this case, the satellite is transparent, and may simply serve to transmit the beams.

In step S810, the GW may determine an SSB for identifying a second link between the satellite and the terminal. Here, determining the SSB for identifying the second link may include identifying how many beams the satellite can use. For example, if the first satellite 310 described in FIG. 5 can use three beams, the first satellite 310 may have three second links. Accordingly, the GW may determine an SSB capable of distinguishing each of the three links (or three beams) of the first satellite 310. As another example, when the second satellite 320 described in FIG. 5 can use four beams, the second satellite 320 may have four second links. Accordingly, the GW may determine an SSB capable of distinguishing each of the four links (or four beams) of the second satellite 320. Thereafter, the GW may inform the satellite of SSBs for identifying the second links in step S810. As another example, the GW may not inform the satellite of SSBs for identifying the second links in step S810. In this case, the satellite is transparent, and may simply serve to transmit the beams.

In step S820, the GW may check whether an SSB transmission time point arrives. Here, the SSB transmission time point may be a synchronization signal transmission time point within the SS burst set described in FIG. 1B. As a result of the checking in step S820, when the SSB transmission time point arrives, the GW may proceed to step S830.

In step S830, the GW may control the satellite to transmit the SSBs for identifying the first link and the second link. In this case, the SSBs for identifying the first link and the second link may be transmitted according to one of the methods of FIGS. 6A to 6C of the present disclosure. As another example, the SSBs for identifying the first link and the second link may be transmitted in the method described in FIG. 5. As another example, the SSBs for identifying the first link and the second link may be transmitted using the method described in FIG. 3B.

The above description has been based on the case where the GW controls the satellites. However, the satellite may be configured to receive information on the satellite identification SSB for the first link between the satellite and the GW from the GW, and determine beam identification SSBs based thereon.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method for a gateway to transmit synchronization signal blocks (SSBs) through a plurality of satellites, the method comprising:
determining satellite identification SSBs for respectively identifying the plurality of satellites;
determining beam identification SSBs for respectively identifying beams available for each of the plurality of satellites; and
controlling each of the plurality of satellites to transmit the satellite identification SSB and the beam identification SSB through a predetermined resource,
wherein the satellite identification SSB and the beam identification SSBs within one satellite have different SSB indexes.

2. The method according to claim 1, further comprising, when the plurality of satellites transmits beams using a plurality of bandwidth parts,
allocating a common bandwidth part used by all beams and a beam-specific bandwidth part corresponding to each beam for each satellite; and
controlling the beam identification SSB to be transmitted in the common bandwidth part.

3. The method according to claim 2, further comprising controlling the beam identification SSB to be transmitted at a different time for each beam.

4. The method according to claim 2, further comprising controlling the satellite identification SSB to be transmitted through the common bandwidth part.

5. The method according to claim 4, further comprising controlling the satellite identification SSB to be simultaneously transmitted through all the beams.

6. The method according to claim 2, further comprising controlling the satellite identification SSB to be transmitted through the beam-specific bandwidth parts.

7. The method according to claim 6, further comprising:
controlling the satellite identification SSB and the beam identification SSB to be transmitted at a same time when transmitted through one beam; and
controlling the beam identification SSB to be transmitted at a different time for each beam.

8. The method according to claim 2, further comprising configuring the satellite identification SSB and the beam identification SSB as a pair, and controlling the satellite identification SSB and the beam identification SSB, which are configured as the pair, to be transmitted through the common bandwidth part at a preconfigured time interval.

9. The method according to claim 8, further comprising controlling the beam identification SSB to be transmitted after the satellite identification SSB is transmitted.

10. A gateway to transmit synchronization signal blocks (SSBs) through a plurality of satellites, the gateway comprising:
a processor; and
a transceiver for communicating with the plurality of satellites,
wherein the processor is configured to:
determine satellite identification SSBs for respectively identifying the plurality of satellites;
determine beam identification SSBs for respectively identifying beams available for each of the plurality of satellites; and
control each of the plurality of satellites to transmit the satellite identification SSB and the beam identification SSB through a predetermined resource,
wherein the satellite identification SSB and the beam identification SSBs within one satellite have different SSB indexes.

11. The gateway according to claim 10, wherein when the plurality of satellites transmits beams using a plurality of bandwidth parts, the processor is further configured to:
allocate a common bandwidth part used by all beams and a beam-specific bandwidth part corresponding to each beam for each satellite; and
control the beam identification SSB to be transmitted in the common bandwidth part.

12. The gateway according to claim 11, wherein the processor is further configured to control the beam identification SSB to be transmitted at a different time for each beam.

13. The gateway according to claim 11, wherein the processor is further configured to control the satellite identification SSB to be transmitted through the common bandwidth part.

14. The gateway according to claim 13, wherein the processor is further configured to control the satellite identification SSB to be simultaneously transmitted through all the beams.

15. The gateway according to claim 11, wherein the processor is further configured to control the satellite identification SSB to be transmitted through the beam-specific bandwidth parts.

16. The gateway according to claim 15, wherein the processor is further configured to:
control the satellite identification SSB and the beam identification SSB to be transmitted at a same time when transmitted through one beam; and
control the beam identification SSB to be transmitted at a different time for each beam.

17. The gateway according to claim 11, wherein the processor is further configured to configure the satellite identification SSB and the beam identification SSB as a pair, and control the satellite identification SSB and the beam identification SSB, which are configured as the pair, to be transmitted through the common bandwidth part at a preconfigured time interval.

18. The gateway according to claim 17, wherein the processor is further configured to control the beam identification SSB to be transmitted after the satellite identification SSB is transmitted.

19. A method of transmitting synchronization signal blocks (SSBs), performed by a satellite, the method comprising:
receiving, from a gateway, satellite identification SSBs for identifying satellites;
determining beam identification SSBs for identifying beams available for the satellite;
when beams are transmitted using a plurality of bandwidth parts, allocating a common bandwidth part used by all the beams and a beam-specific bandwidth part corresponding to each beam;
configuring the beam identification SSB to be transmitted in the common bandwidth part; and configuring the beam identification SSB to be transmitted at a different time for each beam; and
transmitting the satellite identification SSB and the beam identification SSB through respective beams at an SSB transmission time point,
wherein the satellite identification SSB and the beam identification SSBs within one satellite have different SSB indexes.

20. The method according to claim 19, wherein the satellite identification SSB and the beam identification SSB are transmitted at a same time within one beam, and the beam identification SSBs for different beams are transmitted at different times.
